(19) United States
(12) Patent Application Publication
(10) Pub. No.: US 2009/0241152 A1
(43) Pub. Date: Sep. 24, 2009

(54) DIGITAL BROADCAST RETRANSMISSION APPARATUS AND METHOD

(75) Inventor: Yoshinobu TAKAGI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/406,347

(22) Filed: Mar. 18, 2009

(30) Foreign Application Priority Data
Mar. 18, 2008 (JP) 2008-068773

(51) Int. Cl. H04N 7/173

(52) U.S. Cl. 725/109

(57) ABSTRACT

A receiver unit demodulates a digital broadcast wave and reproduces an MPEG2 transport stream. When a contents change is detected in the MPEG2 transport stream, a network processor adds identification information to the frame corresponding to the MPEG2 transport stream of the contents change. The MPEG2 transport stream to which the identification information is added is accumulated in a storage unit. A network processor reads out the MPEG2 transport stream making use of the identification information and transmits it to the IP network through a switch.

### CROSS-REFERENCE TO RELATED APPLICATIONS

This application is based upon and claims the benefit of priority from the prior Japanese Patent Application No. 2008-68773 filed on Mac. 18, 2008, the entire contents of which are incorporated herein by reference.

### BACKGROUND OF THE INVENTION

1. Field of the Invention

The embodiments relate to an apparatus and a method for receiving digital broadcast information and retransmitting digital broadcast information to an IP (Internet Protocol) network.

2. Description of the Related Art

Conventionally, communication and broadcasting are not carried out through the same channel. Specifically, in communication, information is basically transmitted bi-directionally between end users (point-to-point), whereas in broadcasting, information is broadcasted to an unspecified large number of users unilaterally.

However, the Internet has been developed recently, and broadcast contents have been digitized. Accordingly, a fusion of communication and broadcasting is being carried out. Furthermore, IP retransmission is being examined as a supplement system for relaying the terrestrial wave of terrestrial digital television broadcasts. Accordingly, it is required to develop an apparatus for receiving digital broadcast information and retransmitting digital broadcast information to the IP network.

FIG. 15 is a view of a basic arrangement of an IP retransmission system. In FIG. 15, a broadcast station 101 transmits a digital broadcast wave. Digital broadcast information is transferred through the digital broadcast wave. An IP retransmission apparatus 102 receives and demodulates the digital broadcast wave. The reproduced digital broadcast information is accumulated in a storage provided by the IP retransmission apparatus 102. Then, the IP retransmission apparatus 102 retransmits the accumulated digital broadcast information through the Internet 103 in response to a request from a user.

### SUMMARY

A reproduction unit demodulates a digital broadcast wave and reproduces moving image data.

A detection unit detects a contents change in the moving image data obtained by the reproduction means.

An addition unit adds, when the contents change is detected by the detection unit, identification information to the moving image data to indicate the start position of contents.

An accumulation unit accumulates the moving image data to which the identification information is added.

A transmission unit reads out the moving image data stored in the accumulation unit by using the identification information and transmits the moving image data.

### BRIEF DESCRIPTION OF THE DRAWINGS

FIG. 1 is a view explaining an outline of digital broadcast retransmission of an embodiment;

FIG. 2 is a view illustrating an arrangement of an IP retransmission apparatus;

FIG. 3 illustrates an example of identification information;

FIG. 4 illustrates an example of a retransmission management table;

FIG. 5 is a flowchart illustrating a time synchronization process;

FIG. 6 is a flowchart illustrating a process when an IP packet is received;

FIG. 7 is a view illustrating a data structure of a distribution reservation/cancel packet;

FIG. 8 is a flowchart of a process for an instruction to accumulate contents;

FIG. 9 is a flowchart of a process for adding identification information;

FIG. 10 is a detailed flowchart of the process for adding identification information;

FIG. 11 is a flowchart illustrating a process for retransmitting the accumulated contents;

FIG. 12 is a view explaining an operation of the IP retransmission apparatus of an embodiment;

FIG. 13 illustrates an example of a table for managing a plurality of signal lines;

FIG. 14 is a block diagram illustrating a modified example of the IP retransmission apparatus of an embodiment; and

FIG. 15 is a view of a basic arrangement of an IP retransmission system.

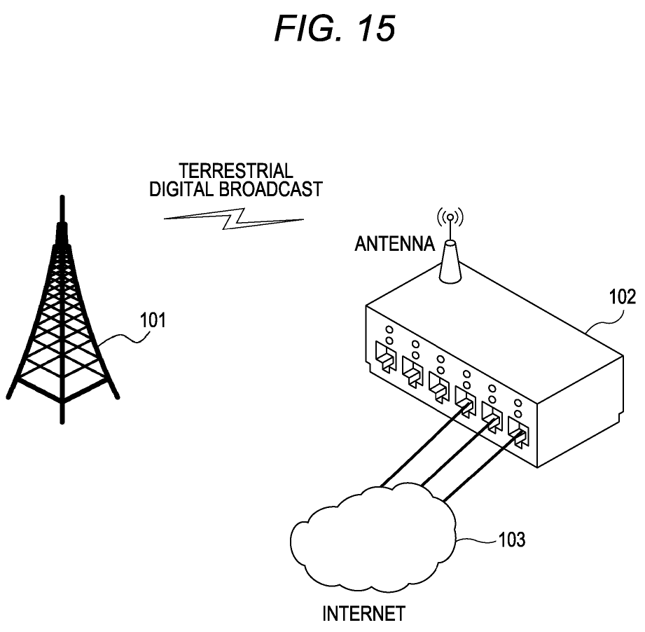

### DETAILED DESCRIPTION OF THE PREFERRED EMBODIMENTS

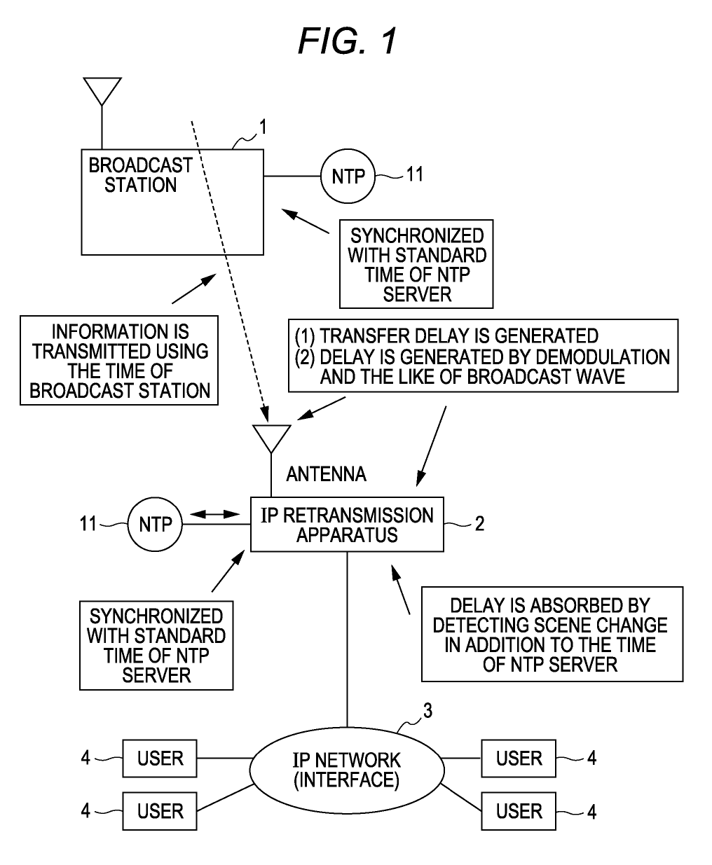

FIG. 1 is a view explaining an outline of digital broadcast retransmission.

In FIG. 1, a broadcast station 1 transmits a digital broadcast wave. Digital broadcast information is content data including, for example, moving images. The broadcast station 1 is operated in synchronism with a standard time by receiving time information from an NTP (Network Time Protocol) server 11. That is, the broadcast station 1 transmits the digital broadcast information in synchronism with the standard time. Note that NTP is a protocol for synchronizing the time of an apparatus connected to a network with a correct time or the standard time.

An IP retransmission apparatus 2 receives and demodulates the digital broadcast wave spontaneously or in response to a request from a user. The content reproduced by demodulation is accumulated in a storage provided by the IP retransmission apparatus 2. The IP retransmission apparatus 2 reads out the contents from the storage and transmits the contents to the user through an IP network in response to a request from a user. The IP retransmission apparatus 2 can execute a process for accumulating the contents to the storage and a process for reading out the contents from the storage and transmitting them in parallel. In this way, substantially simultaneous retransmission is realized. Note that the IP retransmission apparatus 2 is also operated in synchronism with the standard time by receiving the time information from the NTP server 11. That is, the IP retransmission apparatus 2 receives a digital broadcast substantially in synchronism with the broadcast station 1.

However, a transfer delay is generated in the digital broadcast wave due to the distance between the broadcast station 1 and the IP retransmission apparatus 2 and due to a wireless transmission environment. Furthermore, a delay is also generated when the digital broadcast wave is demodulated (and decoded). Accordingly, the IP retransmission apparatus 2 provides a function for absorbing these delays. In the example, the function is realized by detecting a contents change in a reproduced moving image and detecting a start position of the contents making use of the timing of detection.

An IP network 3 is, for example, the Internet, LAN, and/or WAN, and one or a plurality of user terminals 4 is connected to the IP network 3. The user terminals 4 may request the IP retransmission apparatus 2 to retransmit moving image contents. Then, the IP retransmission apparatus 2 fetches the designated moving image contents from the storage and transmits them to the user terminals 4 through the IP network 3.

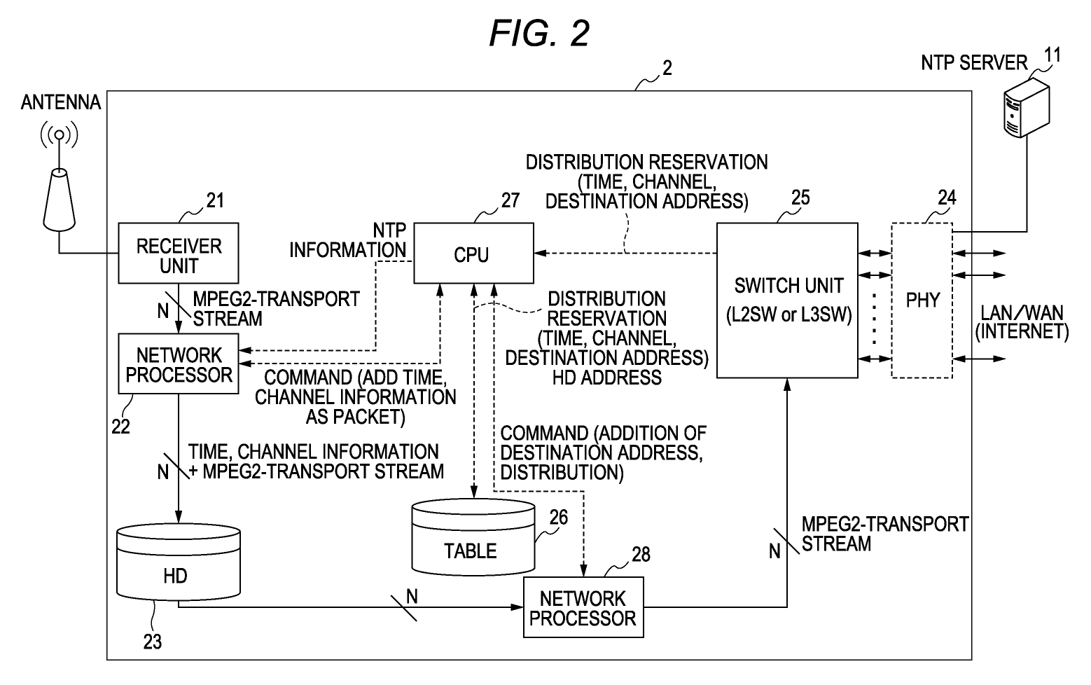

FIG. 2 is a view illustrating a configuration of the IP retransmission apparatus 2. The IP retransmission apparatus 2 has a receiver unit 21, a network processor 22, a storage (HD) 23, a physical layer chip (PHY) 24, a switch unit 25, a retransmission management table 26, a CPU 27, and a network processor 28.

The receiver unit 21 amplifies a received digital broadcast wave and further subjects the digital broadcast wave to a demodulation process. The demodulation process includes A/D conversion and a decode process. In the embodiment, an MPEG2 transport stream may be obtained by the demodulation process. The MPEG2 transport stream includes moving image data and audio data. The MPEG2 transport stream is sent to the network processor 22.

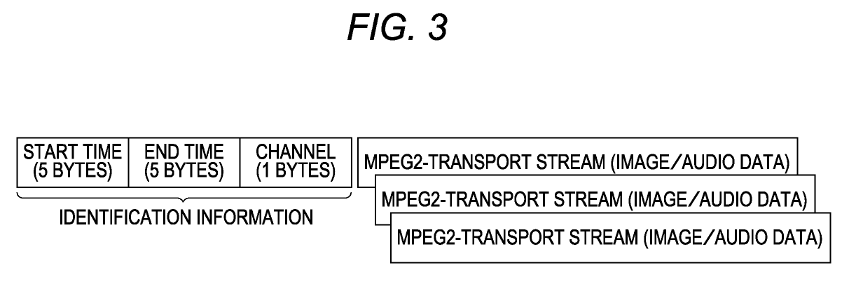

The network processor 22 accumulates the MPEG2 transport stream in the storage 23 in response to an instruction from the CPU 27. The network processor 22 adds identification information to the leading end of the contents of the MPEG2 transport stream. As illustrated in FIG. 3, the identification information is composed of “a recording start time”, “a recording end time”, and “a channel number”. “The recording start time” and “the recording end time” are set according to the time at which contents are broadcasted by the broadcast station 1 instead of the time measured by a clock provided to the IP retransmission apparatus 2. With this operation, the transfer delay and the demodulation delay are absorbed. “The channel number” identifies a channel for broadcasting the contents to be accumulated. Note that the network processor 22 may be realized by an integrated circuit such as FPGA, ASIC, and the like.

The storage 23 may be, for example, a hard disc and stores the MPEG2 transport stream to the address designated by the CPU 27. When the contents requested by a user are accumulated, the identification information is added to the MPEG2 transport stream. Note that the storage 23 is not limited to the hard disc and may be another recording medium.

The physical layer chip 24 is an LSI for terminating a physical layer of a standard for supporting an IP communication. In the example, IP network interfaces such as 10/100 BASE-TX, 1000 BASE-X, 10 GBASE-X, and the like are provided. Note that wireless interfaces such as IEEE802.11 wireless LAN, BLUETOOTH (registered trademark), mobile WiMAX, and the like, or conventional interfaces such as SONET/SDH and the like, may be provided as the physical layer chip 24.

The switch unit 25 is, for example, a layer 2 switch or a layer 3 switch and is an LSI for guiding an IP packet to an address channel. The IP packet, which is input through the physical layer chip 24, is guided to the CPU 27 when the destination address of the IP packet is the address of the apparatus itself, otherwise the IP packet is transferred according to a routing table provided in the switch unit 25. Further, the switch unit 25 transmits the IP packet received from the network processor 28 to the IP network.

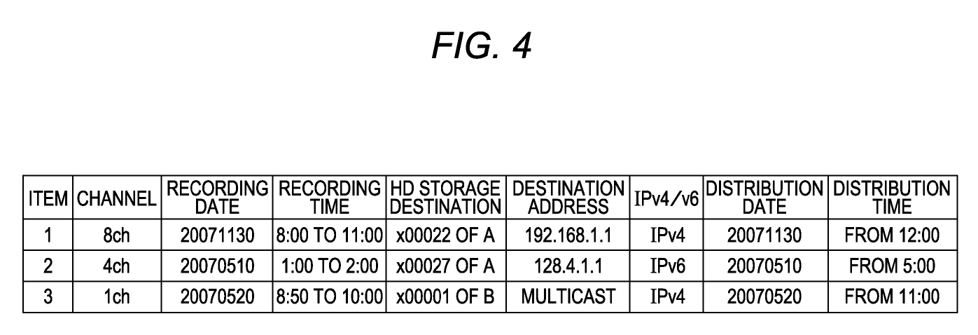

The retransmission management table 26 is a database made by the CPU 27 and manages a retransmission request received from a user. FIG. 4 illustrates an example of the retransmission management table 26. In FIG. 4, “Channel” identifies the channel for broadcasting contents to be retransmitted. “Recording date” shows the year, month, and date on which the contents to be retransmitted are broadcasted by the broadcast station 1. “Recording time” shows the time frame in which the contents to be retransmitted are broadcasted by the broadcast station 1. “HD storage destination” shows the address of the storage 23 for storing the MPEG2 transport stream of the contents to be retransmitted. “Destination address” shows the address to which the contents are transmitted. Note that the destination address may be a multicast address. “IPv4/v6” shows the version of IP when the contents are transmitted. “Distribution date” shows the year, month, and date on which the contents are retransmitted, and “Distribution time” shows the time at which retransmission of the contents is started.

The CPU 27 controls an operation of the IP retransmission apparatus 2. Management of time, processing of a reception IP packet, update of the retransmission management table 26, instruction to the network processor 22 (addition of identification information, and the like), instruction to the network processor 28 (reading-out of contents and the like) are performed as the controls directly related to the embodiment. Note that these processes will be explained in detail later.

The network processor 28 fetches the MPEG2 transport stream from the storage 23 according to the instruction from the CPU 27. As illustrated in FIG. 3, identification information is added to the MPEG2 transport stream when it is accumulated in the storage 23. Accordingly, the network processor 28 can confirm the integrity of the retransmission request by referring to the identification information. The MPEG2 transport stream fetched from the storage 23 is packetized and sent to the switch unit 25 after the identification information is removed. The destination address registered to the retransmission management table 26 is set to the headers of respective packets. The network processor 28 may be also realized by an integrated circuit such as FPGA, ASIC, and the like.

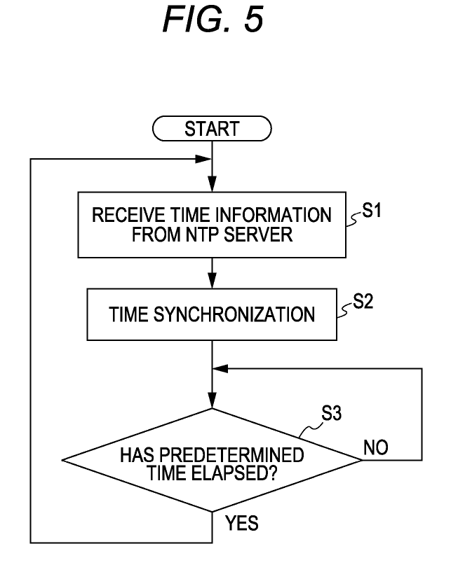

FIG. 5 is a flowchart of a time synchronization process. The process illustrated in the flowchart of FIG. 5 is started when the IP retransmission apparatus 2 is started and executed by the CPU 27.

The IP retransmission apparatus 2 accesses the NTP server 11 at S1 and receives time information. Time synchronization is performed at S2. That is, a clock provided to the CPU 27 is adjusted making use of the received time information. With this operation, the IP retransmission apparatus 2 can be operated in synchronism with a standard time. The time elapsed from the time when the process at S2 was performed is monitored at S3. When a specific amount of time passes, the process returns to the process at S1 and executes the synchronization process. As described above, the IP retransmission apparatus 2 executes the time synchronization when started and repeatedly executes the time synchronization periodically. The CPU 27 sends to the network processor 22 the time information which is synchronized with the standard time.

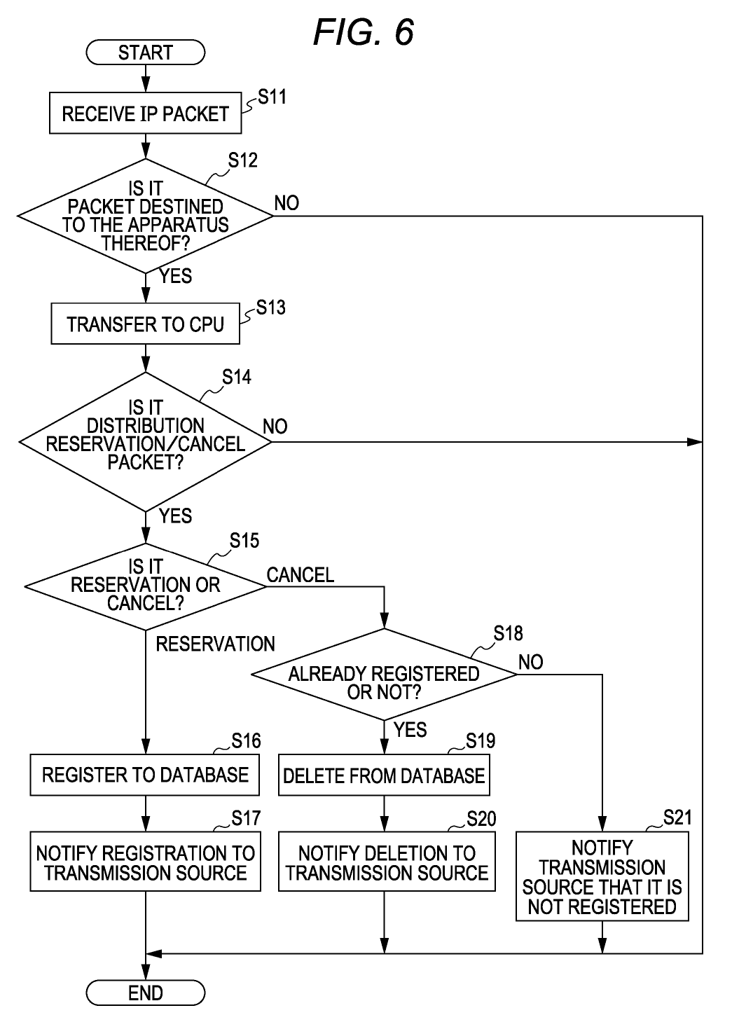

FIG. 6 is a flowchart of the process when the IP packet is received. The processing of the flowchart of FIG. 6 is executed by the switch unit 25 and the CPU 27.

When the IP packet is received at S11, a check is performed to determine whether or not the IP packet is addressed to the apparatus itself(that is, the IP retransmission apparatus 2) at S12. The destination of the IP packet is determined by referring to the destination addresses stored in a header. When the IP packet is addressed to the apparatus itself, the packet is transferred to the CPU 27 at S13. Otherwise, a transfer process is performed according to the routing table.

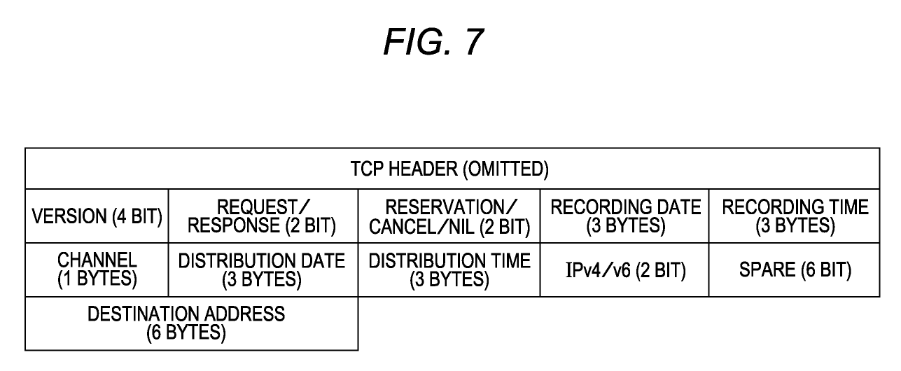

At S14, a check is performed to determine whether or not the received IP packet is a distribution reservation/cancel packet. A data structure of the distribution reservation/cancel packet is illustrated in FIG. 7. The distribution reservation/cancel packet stores information as to the reservation of retransmission or the cancellation of the reservation. The information is stored in a payload of a TCP packet.

The “Version” indicates the version of the distribution reservation/cancel packet. Examples of the “Version” include:

Version 1: “0001”

Version 2: “0010”

The “Request/response” identifies a request for retransmission from a user terminal to the IP retransmission apparatus 2 and a response from the IP retransmission apparatus 2 to the user terminal. Examples of the “Request/response” include:

Request for retransmission: “01”

Response: “10”

The “Reservation/cancel/nil” identifies the reservation of retransmission from the user terminal to the IP retransmission apparatus 2, the cancellation of the reservation, and the response for notifying that the contents whose reservation is to be canceled do not exist. Examples of the “Reservation/cancel/nil” include:

Reservation: “01”

Cancel: “10”

Response for notifying that the contents whose reservation is to be canceled do not exist: “11”

The “Recording date” indicates the date and time at which broadcast of the contents whose retransmission is requested is started. An example of the “Recording date” is:

Jan. 1, 2007, AM 1:00: “200701010100” (converted into binary)

The “Recording time” indicates the time during which the contents whose retransmission is requested are broadcasted. An example of the “Recording time” is:

Time of the contents is 120 minutes: “120” (converted into binary)

The “Channel” indicates the number of the channel through which the contents whose retransmission is requested are broadcasted. Examples of the “Channel” are:

Channel No. 6: “6” (“00000110” in binary)

Channel No. 8: “8” (“00001000” in binary)

The “Distribution date” indicates the date and time at which retransmission starts. An example includes:

Jan. 1, 2007, AM 3:00: “200701010300” (converted into binary)

The “Distribution time” indicates the time during which the contents whose transmission is requested are broadcasted. An example includes:

Time of the contents is 120 minutes: “120” (converted into binary)

“IPv4/v6” indicates the version of IP when the contents are transmitted. Examples include:

IPv4: “01” IPv6: “10”

The “Distribution address” indicates the destination address to which the contents are transmitted. An example includes:

00-00-0E-00-00-01: “00000E000001”

Returning to FIG. 6, at S14, determination is performed referring to the “Version” set to the payload of the TCP of the reception IP packet and the “Request/response”. When the reception packet is the distribution reservation/cancel packet, the “Reservation/cancel/nil” is referred to at S15. When the reservation of retransmission is requested, the contents of the reservation are registered to the retransmission management table 26 (S16). The contents of the reservation are as explained above referring to FIG. 4. At S17, the fact that the reservation of the retransmission has been registered is notified to a request source of the retransmission.

When the cancellation of the reservation of retransmission is requested, the reservation to be canceled is searched for in the reservation information stored in the retransmission management table 26. At S19, a corresponding reservation is deleted from the retransmission management table 26. At S20, the fact that the reservation has been cancelled is notified to the request source. In contrast, when the reservation to be cancelled does not exist in the retransmission management table 26, the fact that the reservation to be cancelled does not exist is notified to the request source at S21.

As described above, when the IP retransmission apparatus 2 receives the reservation request for retransmission from the user terminal 4, the IP retransmission apparatus 2 registers the reservation to the retransmission management table 26. Furthermore, when the IP retransmission apparatus 2 receives a request for canceling the reservation from the user terminal 4, the IP retransmission apparatus 2 deletes the reservation from the retransmission management table 26. The example of the retransmission management table 26 is as illustrated in FIG. 4.

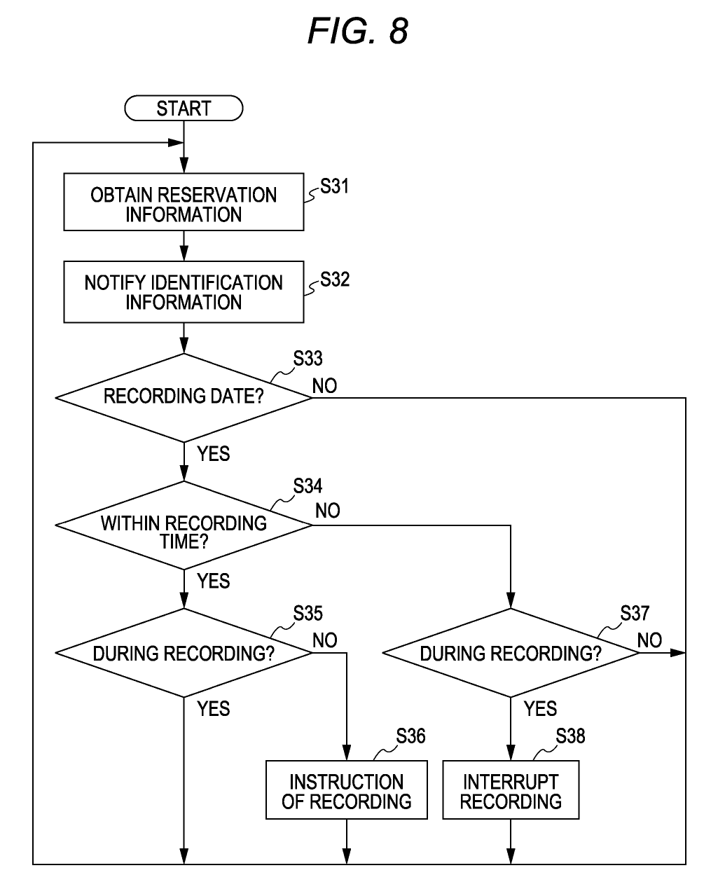

FIG. 8 is a flowchart of a process for an instruction to accumulate the contents.

At S31, the IP retransmission apparatus 2 obtains the reservation information from the retransmission management table 26. At S32, the IP retransmission apparatus 2 creates identification information from the obtained reservation information and sends to the network processor 22 the identification information together with the instruction for accumulating the contents. The identification information is created based on the “Channel”, the “Recording date”, and the “Recording time” of the reservation information. Furthermore, the example of the identification information is illustrated in FIG. 3 and composed of the “Recording start time”, the “Recording end time”, and the “Channel number”. At S33 and S34, a check is performed to determine whether or not the present time is within a recording time designated by the reservation information.

When the present time is within the recording time designated by the reservation information, a check is performed to determine whether or not a recording operation is being executed (S35). When the recording operation is not being executed, the IP retransmission apparatus 2 instructs the network processor 22 and the storage 23 to start the recording operation (S36). With this instruction, the MPEG2 transport stream of the contents reserved by the user is accumulated in the storage 23.

In contrast, when the present time is outside of the recording time designated by the reservation information, a check is performed to determine whether or not the recording operation is being executed (S37). When the recording operation is being executed, the IP retransmission apparatus 2 instructs the network processor 22 and the storage 23 to stop the recording operation (S38). With this instruction, the operation for accumulating the MPEG2 transport stream in the storage 23 is finished.

Note that, in the example illustrated in FIG. 8, only the contents designated by the user are accumulated. At the time, the IP retransmission apparatus 2 may accumulate all the contents to be broadcasted. In this case, it is not always necessary for the IP retransmission apparatus 2 to execute the processes of the flowchart illustrated in FIG. 8.

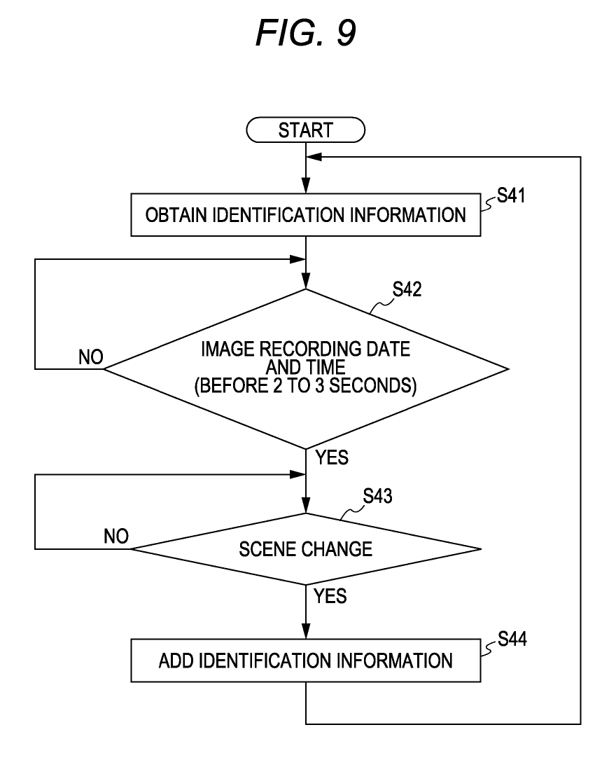

FIG. 9 is a flowchart of a process for adding the identification information to the MPEG2 transport stream. The process is executed by the network processor 22.

At S41, the network processor 22 reads out the identification information sent by the CPU 27. As described above, the identification information indicates the “Start time”, the “End time”, and the “Channel” of the contents to be accumulated in the storage 23. At S42, monitoring is performed to determine whether or not the present time reaches the time obtained by extending back a specific amount of time from the “Start time”. Although the specific amount of time is not particularly limited, it may be, for example, about 2 to 3 seconds. In this case, when the contents the broadcast of which is started at, for example, 7:00 are accumulated, the IP retransmission apparatus 2 goes to S43 at the time when the start time reaches 6:59:57. That is, the process at S43 is executed when the “Start time” is drawing near.

At S43, the IP retransmission apparatus 2 monitors a contents change in the MPEG2 transport stream of the contents designated by the “Channel”. Although the contents change will be explained later in detail, this means in this example that a moving image is discontinued. When the contents change is detected, the identification information is added to the MPEG2 transport stream at S44.

The reason why the contents change is detected is as described below. In general, different contents may be started, for example, a different program or the like, when there is a discontinuity with a moving image immediately in front. It can be assumed that the moving image of the contents that started at for example, 7:00:00, is discontinued once at 7:00:00. Accordingly, when generation of a contents change is monitored from a time extending back a specific amount of time from 7:00, the time “7:00:00” may be detected. Note that the specific amount of time is desirably set longer than the transfer delay and the demodulation delay of the digital broadcast wave. In contrast, when the specific amount of time is set excessively long, a contents change unrelated to the start of the contents may also be detected. Accordingly, it is preferable to set the specific amount of time in consideration of these conditions.

In the digital broadcast retransmission, a delay until the MPEG2 transport stream is reproduced is generated as explained referring to FIG. 1. Accordingly, the time at which the IP retransmission apparatus 2 reproduces the MPEG2 transport stream of certain contents is delayed by several hundreds of milliseconds to several seconds from the time at which the broadcast station 1 broadcasted the contents. However, the IP retransmission apparatus 2 can accurately detect the time of the broadcast station 1 by making use of the contents change as described above.

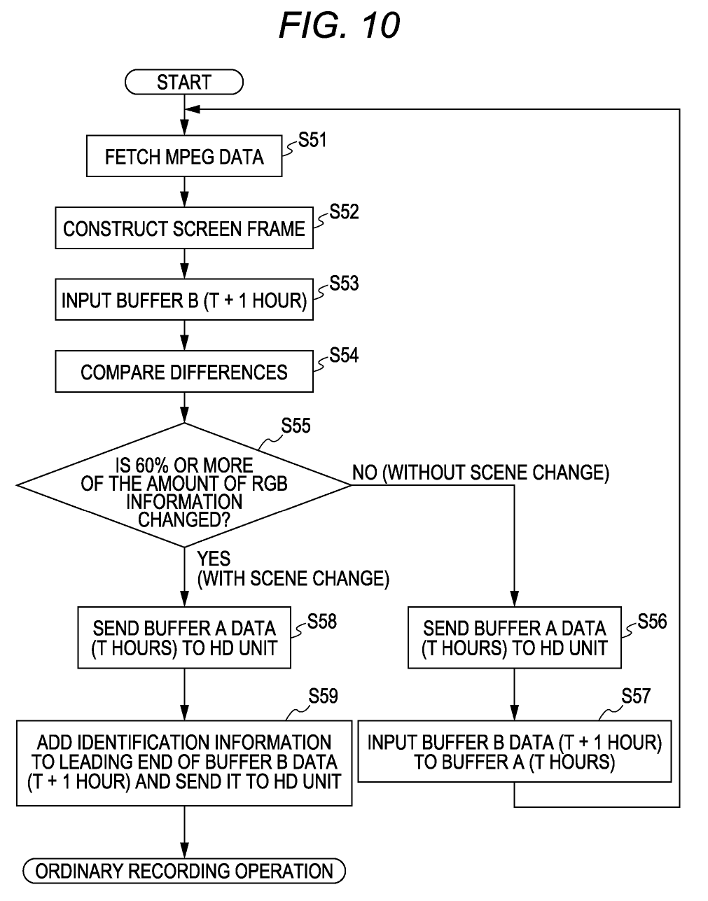

FIG. 10 is a detailed flowchart of the process for adding the identification information to the MPEG2 transport stream. The process corresponds to S43 to S44 illustrated in FIG. 9.

At S51, the IP retransmission apparatus 2 reads the MPEG2 transport stream. At S52, the IP retransmission apparatus 2 constructs a frame for forming a moving image from the MPEG2 transport stream which has been read.

At S53, the IP retransmission apparatus 2 writes the image data of the newly constructed frame to a frame buffer B. The network processor 22 has a frame buffer A and the frame buffer B. The frame buffer A is a memory region for holding a frame image at a time T, and the frame buffer B is a memory region for holding a frame image at a time T+1. That is, the image data of continuous frames of the MPEG2 transport stream are held in the frame buffers A and B.

At S54 to S55, the image data of the corresponding continuous frames from buffers A and B are compared with each other. That is, the image data of the frame at the time T is compared with the image data of the frame at the time T+1. In the present embodiment, the R components, the G components and the B components of each pixel that correspond to each other of one pair of image data are compared with each other. When a change in the R components, the G components, and/or the B components of pixels is larger than a specific threshold value (for example, 60 percent), it is determined that the contents have changed.

When a contents change is not detected, the image data held in the frame buffer A is transmitted to the storage 23 at S56. After the image data held in the frame buffer B is transmitted to the frame buffer A at S57, the process returns to S51.

When a contents change is detected, the image data held in the frame buffer A is transmitted to the storage 23 at S58. Subsequently, at S59, the identification information is added to the leading end of the image data held in the frame buffer A. Then, the image data to which the identification information is added is transmitted to the storage 23. At the time, the storage address of the frame to which the identification information is added may be registered in the retransmission management table 26 as a “storage destination of HD”. Thereafter, an ordinary recording operation is performed. That is, subsequent MPEG2 transport streams are accumulated in the storage 23.

As another method, the “storage destination of HD” may be previously determined when a request from the user is registered to the retransmission management table 26. In this case, when the contents change is detected at S55, the image data from the address, which is held in the frame buffer B at the time T+1 and thereafter, is stored designated by “the storage destination of HD”.

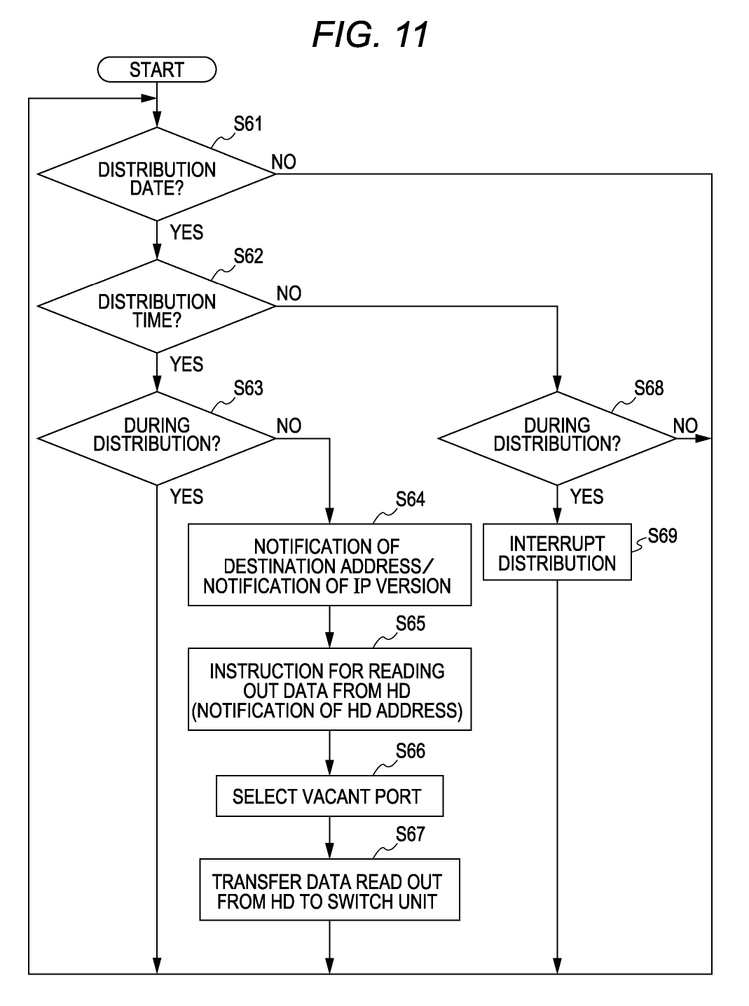

FIG. 11 is a flowchart of a process for retransmitting the accumulated contents. At S61 to S62, a check is conducted to determine whether or not the present time is within a distribution time designated by the reservation information. When the present time is within the distribution time designated by the reservation information, whether or not a distribution operation is being executed is checked at S63. When the distribution operation is not executed, the retransmission management table 26 is referred to, and the destination address of retransmission and the version of IP is sent to the network processor 28 (S64).

At S65, the IP retransmission apparatus 2 instructs the network processor 28 to read out the contents to be retransmitted from the storage 23. The storage address of the contents to be retransmitted is registered as the “storage destination of HD” in the retransmission management table 26. Thus, the network processor 28 reads out the MPEG2 transport stream from the storage 23 based on the “storage destination of HD”. The “storage destination of HD” indicates the storage address of the image data of the frame corresponding to the timing of detection of the contents change. Accordingly, the IP retransmission apparatus 2 can accurately provide the contents of the time frame requested by the user. Furthermore, the network processor 28 checks whether or not the identification information, which is added to the MPEG2 transport stream read out from the storage 23, matches the information which is registered to the retransmission management table 26. Specifically, the network processor 28 checks whether or not a recorded image disclosure time, a recorded image end time, and a channel number match each other.

At S66, a vacant port of the switch unit 25 is selected. Then, the contents read out from the storage 23 are transferred to the switch unit 25 (S67). After the contents received from the broadcast station 1 are accumulated in the storage 23, the contents are retransmitted at a time desired by the user.

Note that when the present time is outside of the distribution time designated by the reservation information, whether or not the distribution operation is being executed is checked at S68. When the distribution operation is being executed, the distribution operation is stopped at S69.

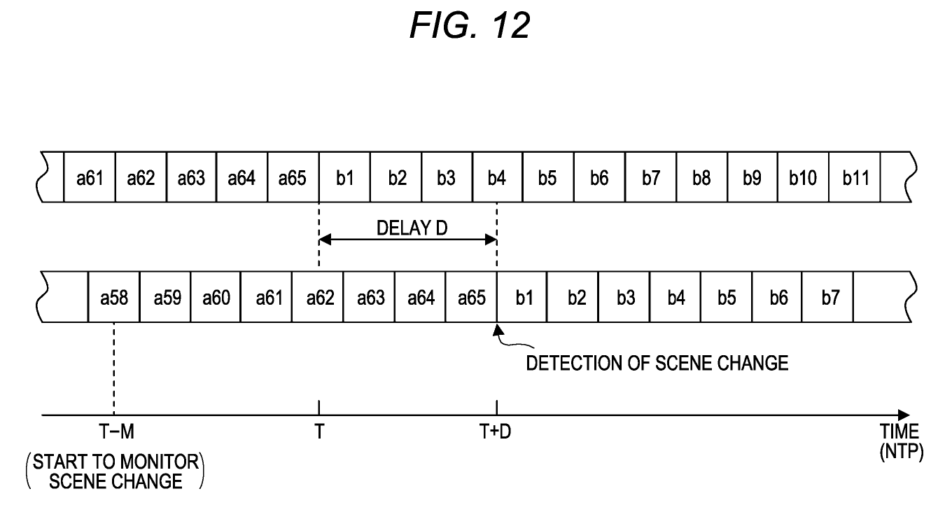

Next, an operation example of the IP retransmission apparatus 2 will be explained referring to FIG. 12. In the example illustrated in FIG. 12, it is assumed that contents “a” (frame . . . , a63, a64, a65) are broadcasted before the time T and contents “b” (frame b1, b2, b3, . . . ) are broadcasted after the time T. Note that it is assumed that clocks provided to the broadcast station 1 and the IP retransmission apparatus 2 are in agreement with each other. Then, it is assumed that the IP retransmission apparatus 2 retransmits the contents “b”.

The IP retransmission apparatus 2 demodulates the digital broadcast wave transmitted from the broadcast station 1 and reproduces the MPEG2 transport stream. It is assumed that a delay D is generated. That is, the reproduced contents “b” are started in the IP retransmission apparatus 2 at a time T+D in place of the time T. In contrast, the IP retransmission apparatus 2 monitors a contents change in the MPEG2 transport stream from the time T−M. Although time M is not particularly limited, M may be, for example, about 2 to 3 seconds.

In the example, a contents change is generated between a frame a65 and a frame b1. When the contents change is detected, the identification information (channel, disclosure time, end time) is added to the image data of the frame b1. Furthermore, the storage address of the frame b1 in the storage 23 is registered to the retransmission management table 26. Thereafter, the MPEG2 transport stream to which the identification information is given is accumulated in the storage 23.

### Other Embodiment

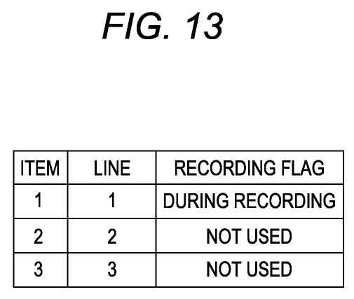

In the IP retransmission apparatus 2 illustrated in FIG. 2, a plurality of signal lines may be disposed between the receiver unit 21 and the network processor 22, between the network processor 22 and the storage 23, between the storage 23 and the network processor 28, and between the network processor 28 and the switch unit 25. In this case, a table for managing the states of the respective signal lines is provided as illustrated in FIG. 13. With this arrangement, a plurality of contents can be accumulated and retransmitted in parallel.

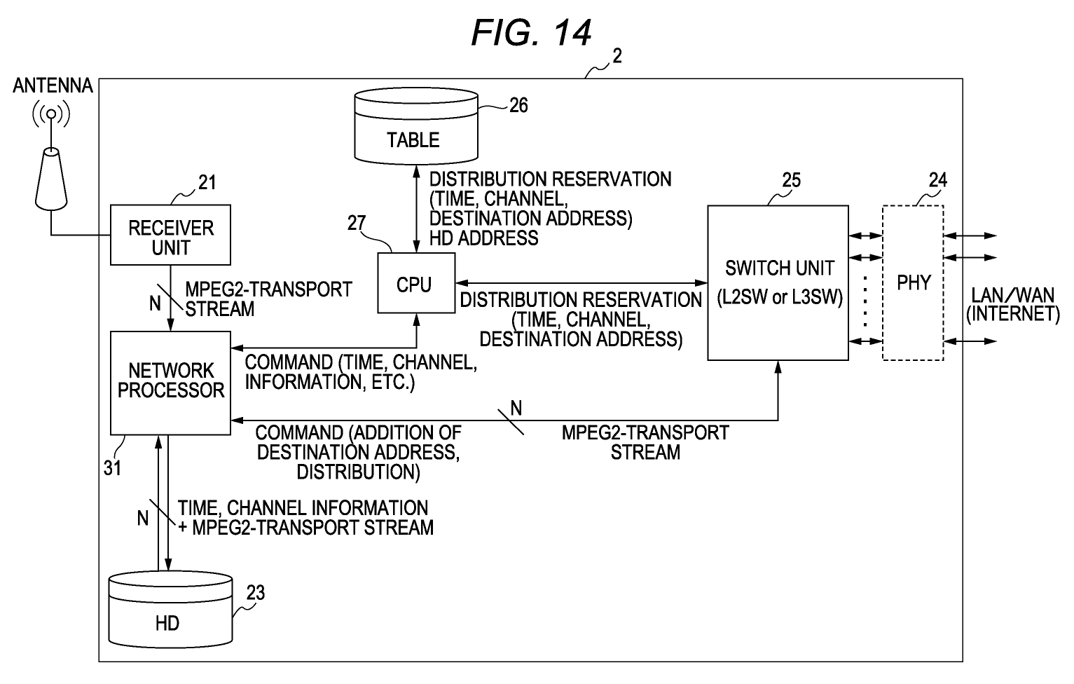

Further, the network processors 22 and 28 illustrated in FIG. 2 may be realized by one chip. In, for example, an embodiment illustrated in FIG. 14, a network processor 31 provides the functions of both the network processors 22 and 28. Note that the network processor 31 may be also realized by an integrated circuit such as FPGA, ASIC, and the like.

1. A digital broadcast retransmission apparatus comprising: reproduction means for demodulating a digital broadcast wave and reproducing moving image data;
detection means for detecting a contents change in the moving image data obtained by the reproduction means;
addition means for adding, when the contents change is detected by the detection means, identification information to the moving image data to indicate the start position of contents;
accumulation means for accumulating the moving image data to which the identification information is added; and
transmission means for reading out the moving image data stored in the accumulation means by using the identification information and for transmitting the moving image data.

2. The digital broadcast retransmission apparatus according to claim 1, wherein the transmission means stores the moving image data in a packet and transmits the moving image data to an IP network.

3. The digital broadcast retransmission apparatus according to claim 1, wherein, when the difference between the pixel data of two continuous frames of the moving image data exceeds a specific threshold value, the detection means determines that the contents change is generated.

4. The digital broadcast retransmission apparatus according to claim 1 further comprising management means for managing a retransmission request for designating contents to be retransmitted,
wherein the detection means detects the contents change from a time extending back a specific amount of time from the start time of the contents designated by the retransmission request.

5. The digital broadcast retransmission apparatus according to claim 4 further comprising clock means which operates concurrently with the time information received from a time management server,
wherein the detection means starts to detect the contents change by using the time measured by the clock means.

6. The digital broadcast retransmission apparatus according to claim 4, wherein the retransmission request includes retransmission time information which indicates the time at which the moving image data is retransmitted, and the transmission means reads out the moving image data from the accumulation means according to the retransmission time information and transmits the moving image data.

7. A digital broadcast retransmission apparatus comprising:
reproduction means for demodulating a digital broadcast wave and reproducing moving image data;
detection means for detecting a contents change in the moving image data obtained by the reproduction means;
accumulation means for accumulating the moving image data using the contents change detected by the detection means as a trigger; and
transmission means for reading out and transmitting the moving image data stored in the accumulation means.

8. A digital broadcast retransmission method comprising:
demodulating a digital broadcast wave and reproducing moving image data;
detecting a contents change in the reproduced moving image data; adding, when the contents change is detected, identification information to the moving image data to indicate the start position of contents;
accumulating the moving image data to which the identification information is added in a storage; and
reading out the moving image data stored in the storage, by using the identification information, and transmitting the moving image data.
